(19) United States
(12) Patent Application Publication
(10) Pub. No.: US 2013/0141008 A1
(43) Pub. Date: Jun. 6, 2013

(54) LED DRIVING DEVICE AND METHOD THEREOF

(71) Applicants: WEI CHANG, NEW TAIPEI CITY (TW); SHAO-WEI CHIU, NEW TAIPEI CITY (TW)

(72) Inventors: WEI CHANG, NEW TAIPEI CITY (TW); SHAO-WEI CHIU, NEW TAIPEI CITY (TW)

(73) Assignee: UNITY OPTO TECHNOLOGY CO., LTD., NEW TAIPEI CITY (TW)

(21) Appl. No.: 13/340,947

(22) Filed: Dec. 30, 2011

(30) Foreign Application Priority Data
Dec. 2, 2011 (TW) 100144330

(51) Int. Cl. H05B 37/02

(52) U.S. Cl. 315/291

(57) ABSTRACT

An LED driving device and its method are suitable for driving and regulating an illumination brightness of at least one LED. After switching the phase angle of an alternating voltage through a regulation circuit, an integration circuit and a filter circuit are utilized to generate a stable constant voltage. Next, the magnitude of the constant voltage is regulated in stage through a driving circuit based upon a control signal of a control circuit, and the voltage is converted into a constant current for driving the LED. Accordingly, the invention utilizes the constant current with stage variation to achieve the effect of linear dimming to prevent flickering.

### CROSS-REFERENCE TO RELATED APPLICATIONS

This non-provisional application claims priority under 35 U.S.C. §119(a) on Patent Application No(s). 100144330 filed in Taiwan, R.O.C. on Dec. 2, 2011, the entire contents of which are hereby incorporated by reference.

### BACKGROUND OF THE INVENTION

1. Field of the Invention

The present invention relates to a technical field of a circuit device of electric light source, and more particularly to a light emitting diode (LED) driving device and its method that linearly regulate the brightness of LEDs by utilizing a bidirectional triode thyristor AC switch (TRIAL) and a control circuit to regulate the magnitude of driving current.

2. Description of the Related Art

Currently, to satisfy varied demand of illuminated light beam with respect to places such as stages, cinemas, or conference rooms or match the environmental protection trend of energy and power saving, different illumination equipment have been applied with dimming devices to achieve effects of automatically or multi-levelly regulating the distribution of illuminated light beam. For example, a common light-emitting diode (LED) lamp switches the conducting angle of inputted voltages through bidirectional triode thyristor, and a voltage drop is formed through a detecting resistor to detect driving current of the LED such that a comparator compares the voltage drop with inputted voltage. When the inputted voltage is greater than the voltage drop, high level voltage is outputted. Otherwise, low level voltage is outputted to conduct or cut off the transistor to regulate duty ratio of pulse width modulation signals such that the magnitude of outputted driving voltages can be regulated to further control the magnitude of driving current and control the light emitting brightness of the LED at the same time.

However, according to characteristic curve of current/voltage (I/V) of the LED, the LED is not a linear component. In another word, the ratio for voltage to current is not direct proportion. Therefore, the foregoing dimming method may not obtain accurate dimming effect since the changed magnitude of driving voltages and driving current is not identical. Further, when voltage frequency, such as 100 Hertz or 120 Hertz, is extremely low, a bidirectional triode thyristor may cause flicker on the LED. Consequently, users' vision may be uncomfortable. On the other hand, when voltage frequency is extremely high, high low level voltage of pulse width modulation signals is changed too fast to cause noise interference. Consequently, LED may abnormally work to reduce practicality.

### SUMMARY OF THE INVENTION

In view of the shortcomings of the prior art, the inventor(s) of the present invention based on years of experience in the related industry to conduct extensive researches and experiments, and finally developed an LED driving device and its method as a principle objective to generate constant current through a control circuit and a driving circuit to linearly regulate a brightness of the LEDs, thereby avoiding flickering or noise interference generated by extremely low or high dimming frequency.

To achieve the foregoing objective of the invention, the LED driving device is suitable for driving and linearly regulating the illumination brightness of at least one LED and includes a regulation circuit, an integration circuit, a control circuit, a filter circuit and a driving circuit. The regulation circuit is electrically connected to a power source and receives alternating current to output a regulated voltage capable of being changed into direct current. The integration circuit is coupled to the regulation circuit and receives the regulated voltage to output an integrated voltage of constant direct current. The control circuit is coupled to the integration circuit and has a comparator and a flip flop. The comparator compares the integration voltage with a sensed voltage to allow the flip flop to output a control signal. Further, the filter circuit is coupled to the regulation circuit and receives the regulated voltage to output a filter voltage of constant voltage. The driving circuit is coupled to the filter circuit and the control circuit and has a sensing resistor to feed back the sensed voltage to the control circuit. The driving circuit regulates the filter voltage based upon the control signal to convert the voltage into a driving current, thereby driving the LED.

The regulation circuit includes a bidirectional triode thyristor and a bridge full-wave rectifier. After the bidirectional triode thyristor receives and regulates the phase conducting angle of the alternating voltage, the rectification is performed by the bridge full-wave rectifier to form the regulated voltage. The control circuit is disposed with an oscillator. The oscillator is coupled to the flip flop to trigger the flip flop timing to output the control signal real-time.

The LED driving device further includes a holding current circuit that is coupled between the regulation circuit and the driving circuit and that has two transistors. The gates of the transistors are coupled to the driving circuit. When the regulation circuit performs dimming to drive the driving circuit, the transistors are conducted to output a holding current to the bidirectional triode thyristor such that the regulation circuit can normally work.

In addition, according to another objective of the invention, the method of driving LED is that a method for driving and regulating the illumination brightness of at least one LED through an LED driving device. The LED driving device includes a regulation circuit, an integration circuit, a control circuit, a filter circuit and a driving circuit. The method includes the following steps: receiving an alternating voltage of a power source through the regulation circuit to output a regulated voltage capable of being changed into direct current; allowing the integration circuit to receive the regulated voltage and output an integration voltage of constant direct current; utilizing a comparator of the control circuit to compare the integration voltage with a sensed voltage such that a flip flop of the control circuit outputs a control signal, and the sensed voltage is fed back and outputted by a sensing resistor of the driving circuit; steadying and filtering the integration voltage through the filter circuit to output a filter voltage of constant voltage; and allowing the driving circuit to regulate the filter voltage based upon the control signal to convert the voltage into a driving current, thereby driving the LED.

The method further includes the following steps: after receiving and regulating phase conducting angle of the alternating voltage through a bidirectional triode thyristor of the regulation circuit, rectifying through a bridge full-wave rectifier of the regulation circuit to form the regulated voltage; when the regulation circuit performs dimming to drive the driving circuit, conducting two transistors of a holding current circuit to provide a holding current to the bidirectional triode thyristor such that the regulation circuit normally works; and triggering the flip flop timing through an oscillator of the control circuit to output the control signal real-time.

### BRIEF DESCRIPTION OF THE DRAWINGS

FIG. 1 is a flowchart according to a preferred embodiment of the present invention;

FIG. 2 is a block diagram of an example according to a preferred embodiment of the present invention;

FIG. 3 is a circuit diagram of an example according to a preferred embodiment of the present invention;

FIG. 4 is a block diagram of another example according to a preferred embodiment of the present invention; and

FIG. 5 is a circuit diagram of another example according to a preferred embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

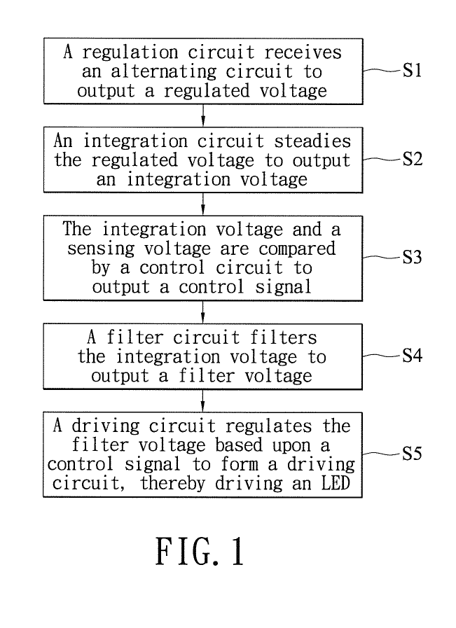

With reference to FIG. 1 for a flowchart according to a preferable embodiment of the invention is disclosed. As shown in the figure, the method of driving LEDs is a method that uses an LED driving device to drive and linearly regulate the illumination brightness of at least one LED. The LED driving device can include a regulation circuit, a holding current circuit, an integration circuit, a control circuit, a filter circuit and a driving circuit. The method includes the following steps:

In step S1, a current voltage of a power source is received by a bidirectional triode thyristor of the regulation circuit, and rectification is performed through a bridge full-wave rectifier of the regulation circuit, and a regulated voltage capable of being changed into direct current is outputted. Further, when the regulation circuit is dimmed to drive the driving circuit, two transistors of the holding current circuit are conducted to provide a holding current to the bidirectional triode thyristor such that the regulation circuit can normally operate.

In step S2, the regulated voltage is transmitted to the integration circuit. An integration voltage of constant direct current is outputted through stable voltage of the integration circuit. More specifically, the integration circuit can be a digital circuit or an analog circuit. Alternatively, the integration circuit can be realized via a look-up table.

In step S3, the integration voltage and a sensing voltage are compared by a comparator of the control circuit to allow a flip flop of the control circuit to output a control signal, and the sensing voltage is fed and output by a sensing resistor of the driving circuit. Moreover, the flip flop is sequentially triggered by an oscillator to output the control signal at real-time.

In step S4, the integration voltage is filtered by a filter capacitor of the filtration circuit to steady the integration circuit so as to form a filter voltage of constant voltage.

Finally, in step S5, the magnitude of the filter voltage is regulated by the driving circuit based upon the control signal, and the filter voltage is converted into a stable driving current to drive the LED. Accordingly, the invention converts phase angular dimming into a manner of current dimming such that flicker generated by the bidirectional triode thyristor due to extremely low dimming frequency can be overcome to prevent the driving circuit from being interfered by excessive high dimming frequency, and therefore abnormal signals outputted by the driving circuit may not occur.

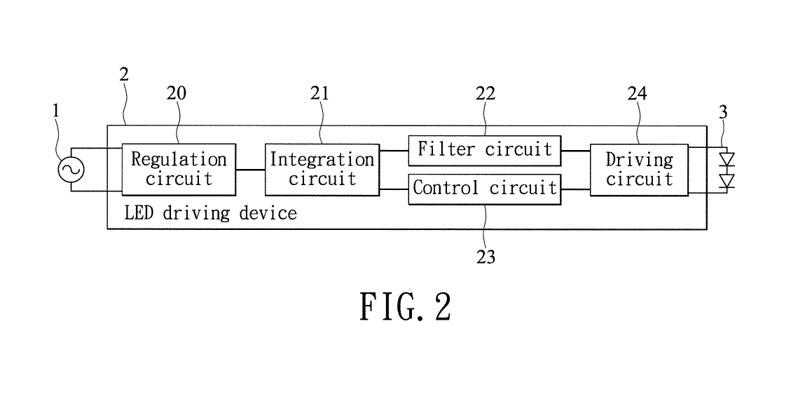

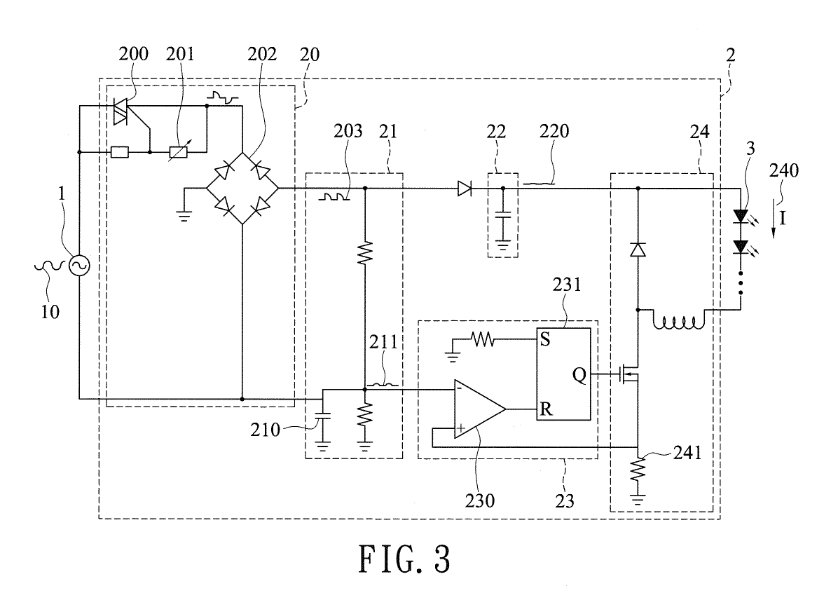

With reference to FIG. 2 and FIG. 3 for a block diagram and a circuit diagram of an example according to a preferred embodiment of the invention are depicted. As shown in the figure, the LED driving device 2 is applied in driving and linearly regulating the illumination brightness of a plurality of LEDs 3 and includes a regulation circuit 20, an integration circuit 21, a filter circuit 22, a control circuit 23 and a driving circuit 24. The regulation circuit 20 is composed of a bidirectional triode thyristor 200, a variable resistor 201 and a bridge full-wave rectifier 202. The bidirectional triode thyristor 200 is coupled to a power source 1 such as distributed power. After receiving and regulating the phase conducting angle of an alternating voltage 1, the rectification is performed by the bridge full-wave rectifier 202 to form a regulated voltage 203 of variable direct current. The regulated voltage then is outputted to the integration circuit 21 and the filter circuit 22. Accordingly, the resistance of the variable resistor 201 is regulated to regulate the phase conducting angle, thereby controlling the magnitude of the regulated voltage 203, and the light emitting brightness of the LEDs can be further controlled.

The integration circuit 21 can be a RC integrator to charge and discharge electricity through an integration capacitor 210 such that the regulated voltage 203 forms an integration voltage 211 of constant direct current, and the integration voltage is outputted to the control circuit 23. The control circuit 23 can be a control chip disposed with a comparator 230 and a flip flop 231. The comparator 230 compares the integration voltage 211 with a sensed voltage to output a compared result. The flip flop 231 is triggered by an oscillator (not shown in the figure), e.g. a quartz oscillator, timing based upon the compared result to output a control signal real-time to the driving circuit 24.

Simultaneously, the filter circuit 22 can be charged or discharged by a capacitor to filter and steady the regulated voltage 203 such that a filter voltage 220 of constant voltage is outputted to the driving circuit 24. Accordingly, when the regulated voltage 230 is increased or reduced to allow the integration voltage 211 to be greater or lower than the sensed voltage, the control signal will regulate the magnitude of the filter voltage 220, and the driving circuit 24 drives the LEDs 3. It should be noted that the driving circuit 24 regulates the voltage magnitude of the filter voltage 220 in stage based upon the control signal, and the voltage is converted into a driving current 240 with stage variation. For example, 5 mA is taken as a variation of density range to linearly regulate the brightness of the LEDs 3.

In the embodiment, the driving circuit 24 can be equipped with a sensing element 241, such as a resistor, for sensing the driving current real-time to form the sensed voltage. Moreover, since the LEDs 3 have features of low driving current 340 and high light emitting efficiency, the LED driving device 2 can regulate the driving current 240 in stage through the control signal to reach accurately low current, thereby reducing power consumption.

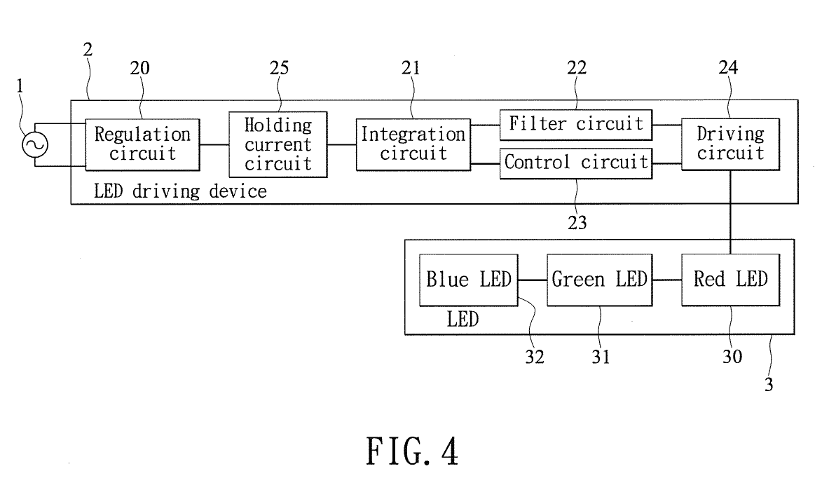

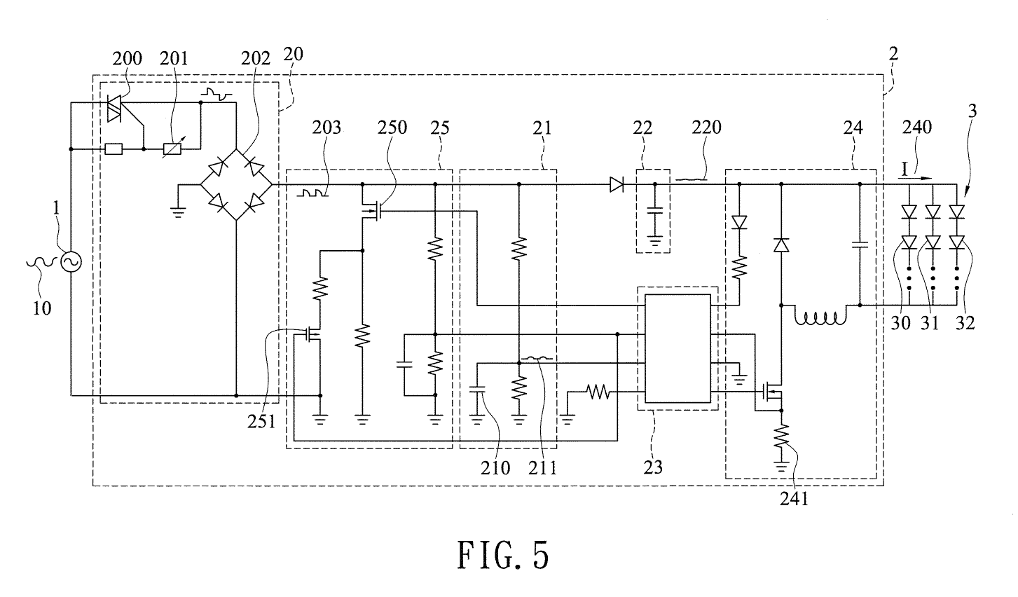

Next, with reference to FIG. 4 and FIG. 5 for a block diagram and a circuit diagram of an example according to a preferred embodiment of the invention are depicted. As shown in the figure, to prevent the LEDs 3 from flickering due to the bidirectional triode thyristor 200 that is unable to be remained as conduction, the LED driving device 2 is further disposed with a holding current circuit 25 to provide a holding current to the bidirectional triode thyristor 200 such that the regulation circuit 20 can normally work. The holding current circuit 25 is coupled between the regulation circuit 20 and the driving circuit 24 and disposed with a first transistor 250 and a second transistor 251. The voltage magnitude of the regulated voltage is directly proportional to the current magnitude of the first transistor 250 and inversely proportional to the current magnitude of the second transistor 251. Therefore, the holding current circuit 25 can provide stable holding current through the operation of the transistors 250, 251.

In addition, the LED driving device 2 can be further connected with a red LED 30, a green LED 31 and a blue LED 32 in parallel to regulate the brightness of the LEDs 30, 31, 32, thereby forming light mixing effect.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An LED driving device suitable for driving and linearly regulating an illumination brightness of at least one LED, the LED driving device comprising:
a regulation circuit, electrically connected to a power source, for receiving an alternating voltage to output a regulated voltage capable of being changed into direct current;
an integration circuit, coupled to the regulation circuit, for receiving the regulated voltage to output an integration voltage of constant direct current;
a control circuit coupled to the integration circuit and having a comparator and a flip flop, the comparator comparing the integration voltage with a sensed voltage to allow the flip flop to output a control signal;
a filter circuit, coupled to the regulation circuit, for receiving the regulated voltage to output a filter voltage of constant voltage; and
a driving circuit coupled to the filter circuit and the control circuit and having a sensing resistor to feed back the sensed voltage to the control circuit, the driving circuit regulating the filter voltage based upon the control signal to convert the filter voltage into a driving current, thereby driving the LED.

2. The LED driving device as recited in claim 1, wherein the regulation circuit includes a bidirectional triode thyristor and a bridge full-wave rectifier, and after the bidirectional triode thyristor receives and regulates phase conducting angle of the alternating current, rectification is performed by the bridge full-wave rectifier to form the regulated voltage.

3. The LED driving device as recited in claim 2, further comprising a holding current circuit coupled between the regulation circuit and the driving circuit and providing a holding current to the bidirectional triode thyristor such that the regulation circuit normally works.

4. The LED driving device as recited in claim 3, wherein the holding current circuit has two transistors, and gates of the transistors are coupled to the driving circuit, and when the regulation circuit performs dimming to drive the driving circuit, the transistors are conducted to output the holding current.

5. The LED driving device as recited in claim 1, wherein the control circuit is disposed with an oscillator, and the oscillator is coupled to the flip flop to trigger the flip flop timing, thereby outputting the control signal.

6. A method for driving an LED that is a method for driving and linearly regulating an illumination brightness of at least one LED through an led driving device, the LED driving device including a regulation circuit, an integration circuit, a control circuit, a filter circuit and a driving circuit, the method comprising steps:
receiving an alternating voltage of a power source to output a regulated voltage capable of being changed into direct current through the regulation circuit;
allowing the integration circuit to receive the regulated voltage and output an integration voltage of constant direct current;
utilizing a comparator of the control circuit to compare the integration voltage and a sensed voltage such that a flip flop of the control circuit outputs a control signal, and the sensed voltage being fed and outputted by a sensing resistor of the driving circuit;
steadying and filtering the integration voltage through the filter circuit to output a filter voltage of constant voltage; and
allowing the driving circuit to regulate the filter voltage based upon the control signal to convert the filter voltage into a driving current for driving the LED.

7. The method for driving an LED as recited in claim 6, further comprising steps:
rectifying through a bridge full-wave rectifier of the regulation circuit to form the regulated voltage after receiving and regulating phase conducting angle of the alternating voltage through a bidirectional triode thyristor of the regulation circuit.

8. The method for driving an LED as recited in claim 7, further comprising steps:
utilizing a current holding circuit to provide a holding current to the bidirectional triode thyristor such that the regulation circuit normally works.

9. The method for driving an LED as recited in claim 8, further comprising steps:
conducting two transistors of the holding current circuit to output the holding current when the regulation circuit performs dimming to drive the driving circuit.

10. The method for driving an LED as recited in claim 6, further comprising steps:
triggering the flip flop timing through an oscillator of the control circuit to output the control signal at real-time.
